(19) United States
(12) Patent Application Publication
(10) Pub. No.: US 2012/0210546 A1
(43) Pub. Date: Aug. 23, 2012

(54) FASTENER AND DISASSEMBLING APPARATUS FOR THE SAME

(75) Inventors: Hong-Min JANG, Seoul (KR); Seong-Hoon Lee, Seoul (KR)

(73) Assignee: ROBOBUILDER CO., LTD., Seoul (KR)

(21) Appl. No.: 13/169,145

(22) Filed: Jun. 27, 2011

(30) Foreign Application Priority Data
Feb. 23, 2011 (KR) 10-2011-0015918

(51) Int. Cl. F16B 1/00; B23P 19/00

(52) U.S. Cl. 24/615; 29/700

(57) ABSTRACT

The present invention relates to a fastener and a disassembling apparatus for the same. The fastener (10) of the present invention has a cylindrical hollow body (12) which configures a framework. A through hole (14) is penetrated through an inside of the hollow body (12) in a longitudinal direction thereof. A plurality of coupling legs (16) are formed by deformation slits (18) to extend toward one end portion of the hollow body (12). A coupling protrusion (20) is formed at an outer surface of the front end of the coupling leg (16), while a releasing portion (24) is formed at an inner side of the hollow body (12) which is opposite to the outer surface. A placing step (22) is formed in a stepwise manner at a location adjacent to the other end portion of the hollow body (12) which corresponds to an opposite side of the coupling protrusion (20). A separating protrusion (28) is formed at an end of the other end portion of the hollow body (12). A disassembling apparatus (30) has a release pin (34) protruding on one side of a frame (32), and a release coupling hole (36) is formed in the release pin (34) so that the releasing portion (24) may be inserted and guided in the release coupling hole (36). The release lever (38) is provided to extend to be spaced apart from the frame (32) at a predetermined interval, and a catching protrusion (40) caught by the separating protrusion (28) is formed at the front end of the release lever (38). According to the present invention, since the fastener (10) for coupling objects (50 and 50′) is configured as a single unit, the number of parts and the number of assembling processes may be reduced, and the fastener (10) may be handled more simply using the disassembling apparatus 30.

### CROSS-REFERENCE TO RELATED APPLICATION

This application claims priority to and the benefit of Korean Patent Application No. 10-2011-0015918 filed in the Korean Intellectual Property Office on Feb. 23, 2011, the entire contents of which are incorporated herein by reference.

### BACKGROUND OF THE INVENTION

1. Field of the Invention

The present invention relates to a fastener and a disassembling apparatus for the same, and more particularly, to a fastener for fastening at least two objects to be coupled and a disassembling apparatus for disassembling the fastener from the objects.

2. Description of the Related Art

Bolts and nuts are and generally and frequently used as a fastening device for detachably fastening at least two objects to be coupled. In addition, rivets are generally used for permanently fastening at least two objects to be coupled.

Recently, various kinds of fasteners with various shapes have been proposed in addition to bolts and nuts as various objects to be coupled are produced. For example, various kinds of fasteners with various shapes are proposed for coupling components of block toys such as Lego or self-assembly robots. In the case of the block toy or the self-assembly robot, two or more components should be coupled to each other to make a desired shape, and these components should be rotatable with respect to each other. In order to satisfy these requirements, bolts and nuts are not appropriate.

Therefore, various fasteners are proposed for fastening such various objects, for example in Korean Patent No. 10-940029. In this patent, a fastener is made of two components such as a fixing pin and a socket, and therefore the number of components is great. In addition, there is a disadvantage in that in order to couple objects to be coupled using the fixing pin and the socket, the socket is firstly installed through the objects and then the fixing pin should be inserted into the socket so cumbersomely.

Moreover, in the above patent, the fixing pin and the socket are very small, and therefore it is very cumbersome for a worker to separate the fixing pin from the socket or to separate the socket from the objects. In particular, in order to separate the socket from the objects, while a separating catching protrusion of the socket is pressed by one hand to elastically deform a can, a catching protrusion at the opposite side of the socket should be pulled by the other hand. Therefore, such a work may cause the workability to be much decreased.

### SUMMARY OF THE INVENTION

The present invention is conceived to solve the aforementioned problems in the prior art, and therefore the present invention is directed to providing a single-pieced fastener which may fasten a plurality of objects to be coupled and allow the objects to be relatively rotatable.

The present invention is also directed to providing a fastener for coupling a plurality of objects to be coupled in which the fastener may be simply separated from the objects.

According to an aspect of the present invention for achieving the objects, there is provided a fastener which includes: a hollow body having a through hole formed through the hollow body in a longitudinal direction thereof; a coupling leg formed to extend in the longitudinal direction of the hollow body by a deformation slit formed to be open to one end portion of the hollow body so that the coupling leg may be elastically deformed; and a releasing portion provided at a location of a front end portion of the coupling leg which corresponds to an inside of the through hole of the hollow body so that the releasing portion receives a force which causes the coupling leg to move toward a center of the through hole, wherein one side of an outer surface of the hollow body and one side of the coupling leg are placed at opposite inlets of respective fastening holes of objects to be coupled to each other.

Preferably, a coupling protrusion is formed on an outer periphery of the front end portion of the coupling leg, and a placing step is formed in a stepwise manner at one side of the outer surface of the hollow body, so that a gap between the coupling protrusion and the placing step allows the objects to be located between the coupling protrusion and the placing step.

Preferably, the coupling leg comprise a plurality of coupling legs spaced from each other at predetermined intervals.

Preferably, the releasing portion extends with a slope toward the center of the through hole.

Preferably, the releasing portion is shaped as a plate whose width gradually decreases toward a front end of the releasing portion.

Preferably, a separating protrusion is formed to protrude around the outer surface of the hollow body on the other end portion of the hollow body which corresponds to an opposite side of the front end portion of the coupling leg.

Preferably, the hollow body has a cylindrical shape.

According to another aspect of the present invention for achieving the objects, there is provided a disassembling apparatus which includes a frame; a release pin protruding on one side of the frame, the release pin having a release coupling hole formed to be open toward a frond end thereof, the release coupling hole allowing a releasing portion of a fastener to be inserted therein and guided thereby; and a release lever formed at the frame so that the release lever serves as a lever with a connection portion between the frame and the release lever as a fulcrum, wherein a catching protrusion is formed at a front end of the release lever so as to face an outer surface of the release pin

Preferably, the frame has a ring shape.

Preferably, the release coupling hole has a release surface with a slope so that a sectional area of a cross-sectional surface of the coupling hole gradually decreases toward an inside of the release coupling hole.

Preferably, the release pin protrudes from a front end of an extending strut which is formed to protrude from the frame so that an outer diameter of the release pin is smaller than or equal to an inner diameter of the fastener.

The fastener and the disassembling apparatus for the same according to the present invention give the following effects.

The fastener of the present invention is configured to be a single piece which couples a plurality of objects through the objects. Therefore, the number of components of the fastener required to fasten the objects to be coupled is minimized, which decreases the number of assembling processes and lowers a production cost.

In addition, if the disassembling apparatus of the present invention is used, the fastener may be coupled to or separated from the objects while the fastener is mounted to the disassembling apparatus. Therefore, even though the fastener has a relatively small size, the fastener may be relatively easily assembled or disassembled, thereby greatly improving workability.

### BRIEF DESCRIPTION OF THE DRAWINGS

FIG. 1 is a perspective view showing a preferred embodiment of a fastener according to the present invention;

FIG. 2 is a sectional view showing the embodiment of the fastener according to the present invention;

FIG. 3 is a sectional perspective view showing a state in which objects are coupled by the fastener of the present invention as shown in the embodiment;

FIG. 4 is a sectional perspective view showing a state in which three objects are coupled by the fastener of the present invention as shown in the embodiment;

FIG. 5 is a perspective view showing a preferred embodiment of a disassembling apparatus according to the present invention;

FIG. 6 shows a usage state in which the disassembling apparatus according to the present invention as shown in the embodiment is used;

FIG. 7 shows an operation state in which a coupling leg of the fastener is elastically deformed due to the disassembling apparatus according to the present invention as shown in the embodiment; and

FIG. 8 is a perspective showing a helicopter toy made by coupling objects using the fastener according to the present invention.

### DESCRIPTION OF THE PREFERRED EMBODIMENT

Hereinafter, a fastener and a disassembling apparatus for the same according to a preferred embodiment of the present invention will be described in detail with reference to the accompanying drawings.

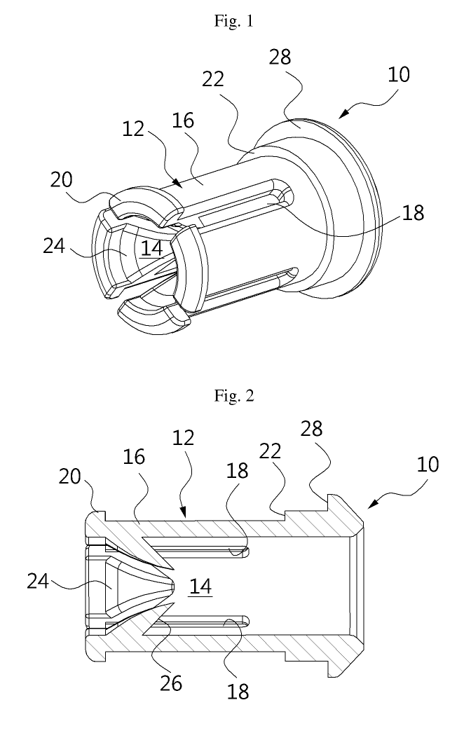

First, a fastener 10 is described with reference to FIGS. 1 to 3. The fastener 10 of this embodiment has a cylindrical hollow body 12 which configures a framework of the fastener 10. The hollow body 12 has a through hole 14 penetrated through an inside of the hollow body 12, so that the hollow body 12 has a cylindrical shape as a whole. The through hole 14 is formed through the hollow body 12 in a longitudinal direction thereof.

The hollow body 12 has a plurality of coupling legs 16 formed to extend toward one end portion thereof. The coupling legs 16 are made by forming deformation slits 18 in the hollow body 12, and the coupling legs 16 are also parts of the hollow body 12. The plurality of coupling legs 16 is symmetrically formed with each other. In other words, the coupling legs 16 are obtained by forming the deformation slits 18 symmetrically in the hollow body 12 and to be spaced apart from each other at predetermined intervals.

Each coupling leg 16 has a cantilever shape and therefore the coupling leg 16 may be elastically deformed. In this embodiment, the length of the coupling leg 16 is set to be at least a half of the entire length of the hollow body 12, but the present invention need not to be limited thereto. The deformation slits 18 are formed up to the one end portion of the hollow body 12 so that each coupling leg 16 has a cantilever shape.

A coupling protrusion 20 is formed at a free end portion of the coupling leg 16. The coupling protrusion 20 is formed to protrude on a region of a front end portion of the coupling leg 16 which corresponds to an outer surface of the hollow body 12. The coupling protrusion 20 is formed over the entire width of the free end portion of the coupling leg 16, but the present invention need not to be limited thereto. That is, the coupling protrusion 20 may be formed over only a part of the free end portion in the width direction thereof. The coupling protrusion 20 is configured to be caught to inlet ends 54 and 54′ of fastening holes 52 and 52′ of objects 50 and 50′ to be coupled as will described later.

A portion of the coupling protrusion 20 toward the front end portion of the coupling leg 16 is formed to have a curved surface. It allows the coupling protrusion 20 to be easily inserted into the fastening holes 52 and 52′ of the objects 50 and 50′. The other portion of the coupling protrusion 20 which is opposite to the curved surface is configured to be flat, so that the flat portion may be caught to the inlet ends 54 and 54′ as will be described later.

A placing step 22 is formed in a stepwise manner around the outer surface of the hollow body 12 which corresponds to the opposite side of the free end portion of the coupling leg 16. The placing step 22 causes the outer surface of the hollow body 12 to have a difference in height, and the placing step 22 is formed to protrude with the same height as the protruding height of the coupling protrusion 20. The placing step 22 is also placed at the inlet ends 54 and 54′ of the fastening holes 52 and 52′.

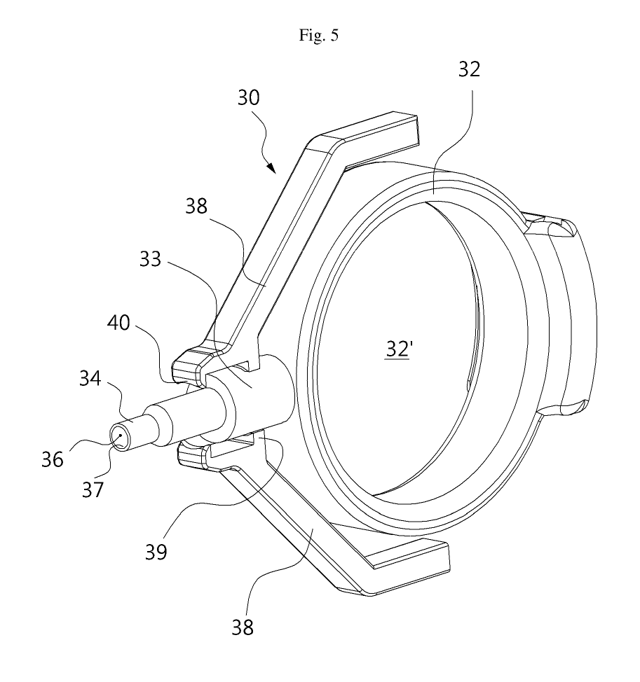

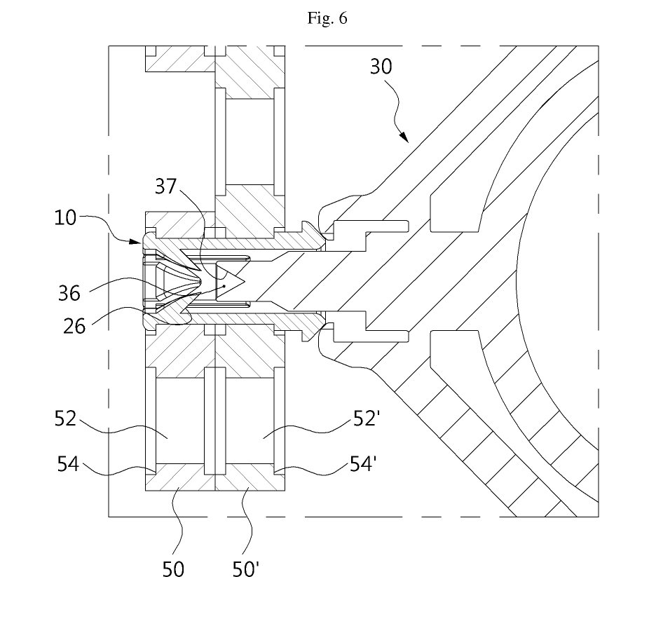

The distance between the coupling protrusion 20 and the placing step 22 is changed according to the number of objects 50 and 50′ to be fastened at once. In this embodiment, the length is long enough to fasten two objects 50 and 50′, but the length may be longer so that more than two objects 50 and 50′ may be coupled. This example is shown in FIG. 4.

A releasing portion 24 is formed at each coupling leg 16. The releasing portion 24 is formed at a region which corresponds to an inner surface of the through hole 14 of the hollow body 12. In other words, the releasing portion 24 is formed to be opposite to the coupling protrusion 20 and extends with a slope in an opposite direction of the free end portion of the coupling leg 16. The releasing portion 24 extends with a slope toward the center of the through hole 14. The releasing portion 24 is shaped as a plate whose width gradually decreases toward the front end of the releasing portion in this embodiment. This shape of the releasing portion 24 allows the releasing portion 24 to be more easily coupled with a release pin 34 according to a disassembling apparatus 30 of the present invention.

A guide surface 26 of the releasing portion 24 which faces the surface of the coupling leg 16 guides the release pin 34 as will be described later, so that the plurality of coupling legs 16 serve to be elastically deformed to be gathered from each other toward the center thereof.

A separating protrusion 28 is formed to protrude on the other end portion of the hollow body 12, i.e. on the opposite end portion of the coupling protrusion 20. The separating protrusion 28 is formed to protrude around the entire outer surface of the other end portion of the hollow body 12 in this embodiment. However, the separating protrusion 28 need not be formed around the entire outer surface of the hollow body 12, so that the separating protrusion 28 may be formed intermittently.

Next, a preferred embodiment of a disassembling apparatus according to the present invention will be described with reference to FIG. 5. The disassembling apparatus 30 of this embodiment includes a frame 32 which configures a framework the disassembling apparatus. The frame 32 is a region to be hand-gripped by a worker and has a ring shape in this embodiment. A hole formed in the frame 32 is a catching hole 32′ into which a finger of the worker is inserted to catch the frame 32.

An extending strut 33 is formed to protrude on one side of the frame 32. The release pin 34 is also formed to protrude on the front end of the extending strut 33. The release pin 34 is configured so that its outer diameter is at least partially smaller than or equal to the inner diameter of the through hole 14 of the hollow body 12. In this embodiment, a certain region of the front end of the release pin 34 is formed to have a smaller outer diameter than the other portion of the release pin 34. Alternatively, the release pin 34 may directly protrude on the frame 32. In other words, there may be no extending strut 33.

A release coupling hole 36 is formed to be open toward the front end of the release pin 34. The release coupling hole 36 serves as a portion into which the releasing portion 24 of the fastener 10 is inserted. A release surface 37 is formed at the inner surface of the release coupling hole 36, and the release surface 37 has a conical shape as a whole. In other words, the release surface 37 allows the cross-sectional surface of the release coupling hole 36 to have a circular shape whose diameter gradually decreases toward an inside of the release coupling hole 36. The release surface 37 guides the front end of the releasing portion 24 so that the coupling legs 16 are elastically deformed to be gathered from each other.

Release levers 38 are symmetrically provided to both sides of the extending strut 33. The release levers 38 are formed to extend so that the release levers are spaced apart from the outer surface of the frame 32 at predetermined intervals. The release levers 38 are connected to the extending strut 33 by a connection portion 39 at a region adjacent to the front end thereof. The connection portion 39 allows a relatively front portion of the release lever 38 to be connected to the frame 32 so that the connection portion 39 may serve as a fulcrum of the lever.

A catching protrusion 40 is formed at the front end of each release lever 38. The catching protrusions 40 protrude toward the extending strut 33 from the front ends of both release levers 38, respectively. The catching protrusion 40 serves as a portion which is caught to the separating protrusion 28 and has a curved portion at a front end thereof which corresponds to the separating protrusion 28. The catching protrusion 40 may push the separating protrusion 28 or may catch and pull the separating protrusion 28.

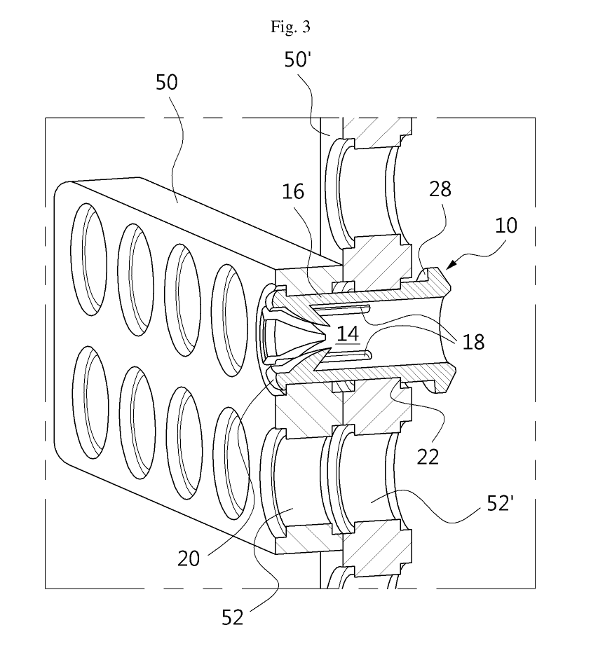

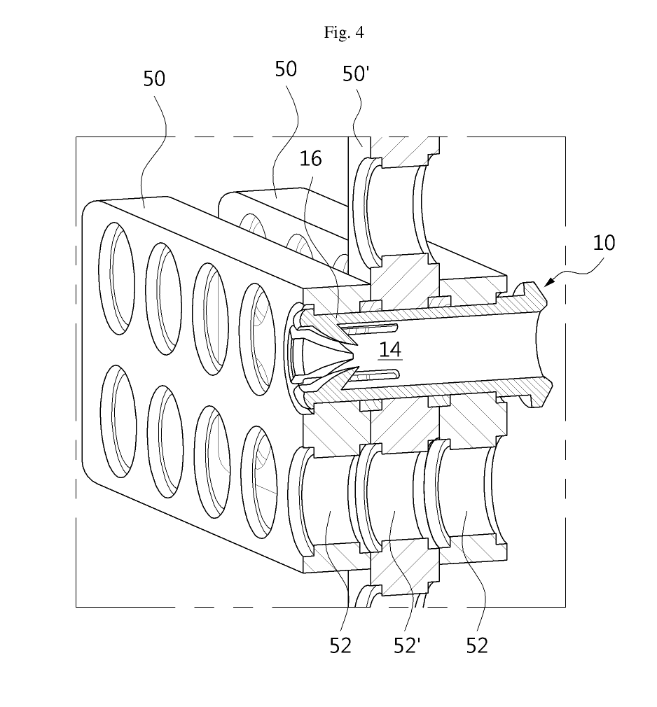

Meanwhile, a first object 50 and a second object 50′ which are coupled to each other by the fastener 10 according to the present invention will be described in brief with reference to FIG. 3. These objects 50 and 50′ may be made with various shapes. In other words, they may have a rectangular shape like the first object 50 or a long strip shape like the second object 50′. For reference, in FIG. 3, the second object 50′ is shown to be cut at its center in a longitudinal direction thereof.

A plurality of first fastening holes 52 and second fastening holes 52′ are formed in the objects 50 and 50′, respectively. In the embodiment as shown, the plurality of first fastening holes 52 are formed in two rows in the first object 50, while the plurality of second fastening holes 52′ are formed in one row in the second object 50′. In addition to the above, objects to be coupled may be made in various shapes.

The first and second fastening holes 52 and 52′ of the objects 50 and 50′ have inlet end portions 54 and 54′ around their inlets, respectively. Each inlet end portion 54 and 54′ is a region where the coupling protrusion 20 or the separating protrusion 28 of the fastener 10 is located. By locating the coupling protrusion 20 or the separating protrusion 28 at the inlet end portion 54 and 54′, the objects 50 and 50′ may be prevented from being moved in a longitudinal direction of the fastener 10.

Hereinafter, the usage of the fastener and the disassembling apparatus for the same according to the present invention, configured as above, will be described in detail.

In the present invention, the fastener 10 fastens the first and second objects 50 and 50′. For this purpose, at least one of the first and second fastening holes 52 and 52′ of the first and second objects 50 and 50′ should be coincided with each other.

The fastener 10 is inserted through the first and second fastening holes 52 and 52′ which has been coincided with each other. At this time, the curved surface of the coupling protrusion 20 formed at the front ends of the coupling legs 16 of the fastener 10 is guided along the inner surfaces of the fastening holes 52 and 52′, so that the coupling legs 16 are elastically deformed to be gathered from each other. It is natural that the fastener 10 may be inserted into the fastening holes 52 and 52′ of the objects 50 and 50′ while the fastener 10 has been inserted into the release pin 34 of the disassembling apparatus 30.

If the fastener 10 passes through the fastening holes 52 and 52′ of the objects 50 and 50′ so that the coupling protrusions 20 of the coupling legs 16 are placed on for example the inlet end portions 54 of the first object 50, the coupling legs 16 are restored to their original state. In this case, the coupling protrusion 20 and the separating protrusion 28 of the fastener 10 are placed on the inlet end portion 54 and 54′ of the first and second objects 50 and 50′ which are oppositely located, respectively. Therefore, the objects 50 and 50′ are located and coupled between the coupling protrusion 20 and the separating protrusion 28 of the fastener 10.

For reference, when the fastener 10 is inserted into the fastening holes 52 and 52′, the separating protrusion 28 may be pushed by the catching protrusion 40 of the release lever 38 while the fastener 10 has been mounted to the release pin 34. At this time, the catching protrusion 40 is not caught to the separating protrusion 28 but is pushed from the outside.

As shown in FIG. 3, while the first and second objects 50 and 50′ have been coupled to each other by the fastener 10, the first and second objects 50 and 50′ may be relatively rotated about the fastener 10. In addition, for example, other objects 50 and 50′ may be coupled with the first object 50 by the fastener 10. If the fastener 10 is used this way, a plurality of objects 50 and 50′ may be coupled successively.

Meanwhile, a process of separating the fastener 10 from the objects 50 and 50′ using the disassembling apparatus of the present invention will be described.

In order to separate the fastener 10 from the fastening holes 52 and 52′ of the objects 50 and 50′, the coupling protrusion 20 should be taken out of the inlet end portion 54. For this purpose, the release pin 34 of the disassembling apparatus 30 is inserted into the through hole 14 of the fastener 10. As the release pin 34 is inserted into the through hole 14, the releasing portion 24 of the coupling leg 16 is inserted into the release coupling hole 36 which is open toward the front end of the release pin 34. If the releasing portion 24 is inserted into the release coupling hole 36, the front end of the releasing portion 24 is guided along the release surface 37 so that the coupling leg 16 is elastically deformed. In other words, the coupling legs 16 are elastically deformed to be adjacent to each other.

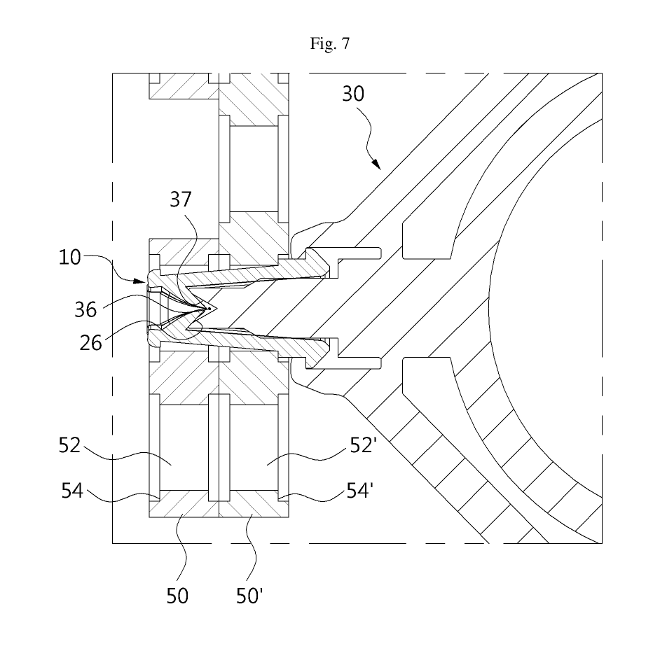

If the coupling legs 16 are elastically deformed to become adjacent to each other, the coupling protrusion 20 moves toward the center of the first fastening hole 52 to be free from the inlet end portion 54. At this time, as shown in FIG. 7, the catching protrusion 40 is still caught to the separating protrusion 28. For making the catching protrusion 40 be caught to the separating protrusion 28, the release pin 34 is inserted into the through hole 14 of the fastener 10 while the rear end of the release lever 38 is moved toward the frame 32, so that the catching protrusion 40 is spaced apart from the outer surface of the release pin 34, thereby passing by the separating protrusion 28 without being disturbed by the separating protrusion 28. Then, the release lever 38 is restored.

Therefore, if the disassembling apparatus 30 is pulled in the state of FIG. 7, the fastener 10 is taken out of the first and second fastening holes 52 while the separating protrusion 28 is pulled by the catching protrusion 40.

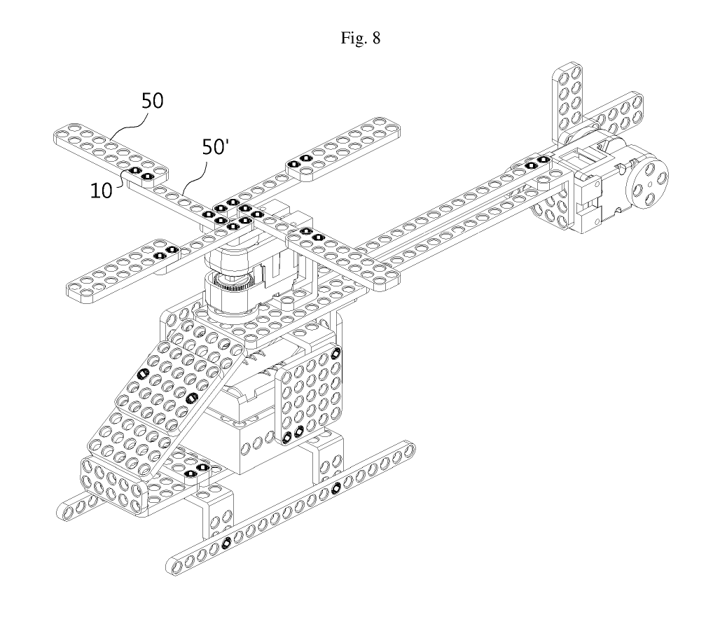

Meanwhile, FIG. 8 shows a helicopter toy which is produced by coupling objects 50 and 50′ using the fastener 10 of the present invention. As understood from FIG. 8, if the fastener 10 of the present invention is used, a plurality of objects 50 and 50′ with the fastening holes 52 and 52′, which have various shapes, may be coupled to configure a desired structure. This toy may have a driving source such as a motor provided therein so that a desired portion may make a predetermined operation.

The scope of the present invention is not limited to the above embodiments but defined by the appended claims, and it is apparent that various changes and modifications can be made within the scope of the present invention defined in the appended claims by those having ordinary skill in the art.

For example, the separating protrusion 28 is not always required. Though the separating protrusion 28 is excluded, the catching protrusion 40 of the disassembling apparatus 30 may be closely adhered to the outer surface of the hollow body 12 to hold and handle the fastener 10.

Reference Numerals

| | |
|---|---|
| 10: fastener | 12: hollow body |
| 14: through hole | 16: coupling leg |
| 18: deformation slit | 20: coupling protrusion |
| 22: placing step | 24: releasing portion |
| 26: guide surface | 30: disassembling apparatus |
| 32: frame | 33: extending strut |
| 34: release pin | 36: release coupling hole |
| 37: release surface | 38: release lever |
| 39: connection portion | 40: catching protrusion |
| 50, 50′: object to be fastened | 52, 52′: fastening hole |

What is claimed is:

1. A fastener, comprising:
a hollow body having a through hole formed through an inside of the hollow body in a longitudinal direction thereof;
a coupling leg formed to extend in the longitudinal direction of the hollow body by a deformation slit formed to be open to one end portion of the hollow body so that the coupling leg is elastically deformed; and
a releasing portion provided at a location of a front end portion of the coupling leg which corresponds to an inside of the through hole of the hollow body so that the releasing portion receives a force which causes the coupling leg to move toward a center of the through hole,
wherein one side of an outer surface of the hollow body and one side of the coupling leg are placed at opposite inlets of respective fastening holes of objects to be coupled to each other.

2. The fastener according to claim 1, wherein a coupling protrusion is formed on an outer periphery of the front end portion of the coupling leg, and a placing step is formed in a stepwise manner at one side of the outer surface of the hollow body so that a gap between the coupling protrusion and the placing step allows the objects to be located between the coupling protrusion and the placing step.

3. The fastener according to claim 2, wherein the coupling leg comprises a plurality of coupling legs spaced apart from each other at predetermined intervals.

4. The fastener according to claim 3, wherein the releasing portion extends with a slope toward the center of the through hole.

5. The fastener according to claim 4, wherein the releasing portion is shaped as a plate whose width gradually decreases toward a front end of the releasing portion.

6. The fastener according to claim 1, wherein a separating protrusion is formed to protrude around the outer surface of the hollow body on the other end portion of the hollow body which corresponds to an opposite side of the front end portion of the coupling leg.

7. The fastener according to claim 2, wherein a separating protrusion is formed to protrude around the outer surface of the hollow body on the other end portion of the hollow body which corresponds to an opposite side of the front end portion of the coupling leg.

8. The fastener according to claim 3, wherein a separating protrusion is formed to protrude around the outer surface of the hollow body on the other end portion of the hollow body which corresponds to an opposite side of the front end portion of the coupling leg.

9. The fastener according to claim 4, wherein a separating protrusion is formed to protrude around the outer surface of the hollow body on the other end portion of the hollow body which corresponds to an opposite side of the front end portion of the coupling leg.

10. The fastener according to claim 5, wherein a separating protrusion is formed to protrude around the outer surface of the hollow body on the other end portion of the hollow body which corresponds to an opposite side of the front end portion of the coupling leg.

11. The fastener according to claim 6, wherein the hollow body has a cylindrical shape.

12. A disassembling apparatus, comprising:
a frame;
a release pin protruding on one side of the frame, the release pin having a release coupling hole formed to be open toward a frond end thereof, the release coupling hole allowing a releasing portion of a fastener to be inserted therein and guided thereby; and
a release lever formed at the frame so that the release lever serves as a lever with a connection portion between the frame and the release lever as a fulcrum, wherein a catching protrusion is formed at a front end of the release lever so as to face an outer surface of the release pin.

13. The disassembling apparatus according to claim 12, wherein the frame has a ring shape.

14. The disassembling apparatus according to claim 13, wherein the release coupling hole has a release surface with a slope so that a sectional area of a cross-sectional surface of the release coupling hole gradually decreases toward an inside of the release coupling hole.

15. The disassembling apparatus according to claim 14, wherein the release pin protrudes from a front end of an extending strut which is formed to protrude from the frame so that an outer diameter of the release pin is smaller than or equal to an inner diameter of the fastener.
